(19) United States
(12) Patent Application Publication
(10) Pub. No.: US 2005/0021918 A1
(43) Pub. Date: Jan. 27, 2005

(54) Memory and information processing systems with lockable buffer memories and related methods

(76) Inventors: Sang-Won Hwang, Gyeonggi-do (KR); Jin-Yub Lee, Seoul (KR)

Correspondence Address: D. Randal Ayers;Myers Bigel Sibley & Sajovec, P.A., P.O. Box 37428, Raleigh, NC, 27627, US

(21) Appl. No.: 10/883,950

(22) Filed: Jul. 2, 2004

(30) Foreign Application Priority Data
Jul. 24, 2003 (KR) 2003-51029

(51) Int. Cl. G06F 12/14

(52) U.S. Cl. 711/163; 711/103; 711/104

(57) ABSTRACT

Methods of controlling a memory system having a non-volatile memory and a volatile memory are provided in which data is received that is to be stored in the non-volatile memory, the received data is temporarily stored in the volatile memory, the temporarily stored data is stored in the non-volatile memory, an address designating a region of the volatile memory as a locked region is received, an input address is received, and it is determined whether the input address corresponds to the locked region. Operation of the non-volatile and volatile memories may also be controlled such that write operations are not performed to the volatile memory if it is determined that the input address corresponds to the locked region.

### CLAIM OF PRIORITY

This application claims priority from Korean Patent Application No. 2003-51029, filed on Jul. 24, 2003, the contents of which is herein incorporated by reference in its entirety.

### FIELD OF THE INVENTION

This disclosure generally relates to memory systems and information processing systems and, more specifically, to memory and information processing systems that buffer memories.

### BACKGROUND OF THE INVENTION

With the proliferation of mobile and other battery powered electronic devices, interest in flash memories and other non-volatile memory systems has been increasing. Flash memories are capable of storing large amounts of data. However, flash memories may have a relatively long data read/write time as compared to random access memory (“RAM”) devices.

One method for reducing the data read/write time associated with a flash memory is to use a combination of a flash memory and a buffer memory. In such a system, data received from a host is not stored directly in the flash memory, but instead is first stored in the buffer memory. The data stored in the buffer memory may then be written from the buffer memory into the flash memory. In a similar fashion, data read from the flash memory is not directly transferred to the host, but instead is stored in the buffer memory. Thereafter, the data stored in the buffer memory is read, and the read data is transferred to the host. Using such a data transmission mode may improve the performance of the device or application in which the memory system is resident.

In many devices and systems, data of increased or very high importance may be stored in a buffer memory portion of the devices′ memory system. For example, the software that boots up the device (referred to herein as “boot code”) may be loaded from a flash memory to a buffer memory when the power switch for the device is turned on. The boot code may also remain or be restored in the flash memory. Other data, such as information transmitted from a host, may be stored only in the buffer memory. Information that is stored in the buffer memory may be susceptible to change for a variety of reasons such as, for example, an erroneous command or a bias. Thus, situations can arise where important information that is stored in the buffer memory may be changed due to, for example, an unintentional write operation.

### SUMMARY OF THE INVENTION

Pursuant to certain embodiments of the present invention, memory devices are provided that include a non-volatile memory, a volatile memory that is configured to store both data that is to be stored in the non-volatile memory and data read from the non-volatile memory, and at least one control circuit that receives an address designating a region of the volatile memory as a locked region. The at least one control circuit may be configured to both generate a flag signal that indicates whether an input address corresponds to the locked region and to control read and write operations of the non-volatile and volatile memories in response to the flag signal such that write operations are not performed to the volatile memory when the flag signal is activated.

In certain embodiments of the present invention, the volatile memory, the non-volatile memory and the at least one control circuit may be formed on a single chip. The at least one control circuit may also control the volatile and non-volatile memories in response to the flag signal such that data stored in the volatile memory is read and stored in the non-volatile memory when the flag signal is activated. The at least one control circuit may also control the non-volatile memory such that read operations of the non-volatile memory are not performed when the flag signal is activated. The at least one control circuit may also control the volatile and non-volatile memories so as to allow write operations to the volatile memory and to allow read operations of the non-volatile memory device when the flag signal is inactivated.

In certain embodiments of the present invention, the at least one control circuit may include an address register that stores an address to appoint the locked region of the volatile memory, a status register that stores information indicating whether the volatile memory is partially or wholly appointed to the locked region, a comparator that may be used to determine whether the input address is identical to the address stored in the address register and a signal generator that generates the flag signal in response to outputs of the status register and the comparator. In these embodiments, when the information stored in the status register indicates that the volatile memory is partially or wholly appointed to the locked region, the signal generator may activate or inactivate the flag signal based on the output of the comparator. In contrast, when the information stored in the status register indicates that the volatile memory is not partially or wholly appointed to the locked region, the signal generator inactivates the flag signal irrespective of the output of the comparator. The at least one control circuit may also initialize the address register and the status register in response to a hardware-reset, a software-reset, and/or a turning on of the power to the memory device. The at least one control circuit may also include a register for storing an address of the locked region and a lock command.

Pursuant to further embodiments of the present invention, memory devices are provided that include a volatile memory, a register that is configured to store an address appointing a locked region of the volatile memory and a lock command, a state machine that is configured to output the address appointing the locked region, the lock command and a control signal when the lock command is input to the register, a control circuit that is configured to (a) store the address appointing the locked region and the lock command in response to the control signal and to (b) generate a flag signal indicating whether an address for appointing a predetermined region of the volatile memory is an address for appointing the locked region, and a first memory controller that is configured to prevent write operations to the volatile memory when the flag signal is activated.

The first memory controller may be configured to make the volatile memory perform an operation corresponding to an input command when the flag signal is activated. The memory device may also include a non-volatile memory, an error correction and data input/output circuit, which is controlled by the state machine and corrects an error of data transmitted between the first memory controller and the non-volatile memory, and a second memory controller which is controlled by the state machine and controls read and write operations of the non-volatile memory. In these devices, when the flag signal is activated, the state machine may control the first and second memory controllers so that data is read from the volatile memory and stored in the non-volatile memory. When the flag signal is activated, the state machine may control the second memory controller so that read operations of the non-volatile memory are not performed.

In certain embodiments of the present invention, the control circuit may include an address register that is configured to store the address appointing the locked region in response to the control signal, a status register that is configured to store the lock command in response to the control signal, a comparator that compares the address in the address register to the address appointing a predetermined region of the volatile memory and a signal generator that generates the flag signal in response to outputs of the status register and the comparator. When the information stored in the status register indicates that the volatile memory is partially or wholly appointed to the locked region, the signal generator may activate or inactivate the flag signal based on the output of the comparator. When the information stored in the status register indicates that the volatile memory is not partially or wholly appointed to the locked region, the signal generator inactivates the flag signal irrespective of the output of the comparator.

Pursuant to still further embodiments of the present invention, methods of controlling a memory system having a non-volatile memory and a volatile memory are provided. Pursuant to these methods, data is received that is to be stored in the non-volatile memory, the received data is temporarily stored in the volatile memory, the temporarily stored data is stored in the non-volatile memory, an address designating a region of the volatile memory as a locked region is received, an input address is received, and it is determined whether the input address corresponds to the locked region. Operation of the non-volatile and volatile memories may also be controlled such that write operations are not performed to the volatile memory if it is determined that the input address corresponds to the locked region. Both the volatile and non-volatile memories may be controlled such that data read from the volatile memory is stored in the non-volatile memory and so that write operations of the volatile memory are not performed if it is determined that the input address corresponds to the locked region.

Pursuant to still further embodiments of the present invention, methods of controlling a memory system having a volatile memory are provided in which both an address appointing a locked region of the volatile memory and a lock command are stored. A flag signal is generated indicating whether an address for appointing a predetermined region of the volatile memory is an address for appointing the locked region. When the flag signal is activated, write operations to the volatile memory are prevented.

While embodiments of the present invention have been primarily described above in the context of memory devices and methods, it will be appreciated in light of the present disclosure that corresponding systems are also provided.

### BRIEF DESCRIPTION OF THE DRAWINGS

FIG. 1 is a block diagram of an information processing system including a memory device according to some embodiments of the present invention.

FIG. 2 is a block diagram of a lock controller according to some embodiments of the present invention.

### DETAILED DESCRIPTION

The present invention will now be described more fully with reference to the accompanying drawings, in which typical embodiments of the invention are shown.

This invention, however, may be embodied in many different forms and should not be construed as limited to the embodiments set forth herein. Rather, these embodiments are provided so that this disclosure will be thorough and complete, and will fully convey the scope of the invention to those skilled in the art. Also, as used herein, the term “and/or” includes any and all combinations of one or more of the associated listed items. Like reference numerals refer to like elements throughout.

Memory devices according to certain embodiments of the present invention may include a buffer memory. The buffer memory may be used to store general information, important information (e.g., boot code) or a combination of the two. Memory devices according to certain embodiments of the present invention may reduce the likelihood that unintentional operations change information stored in the buffer memory.

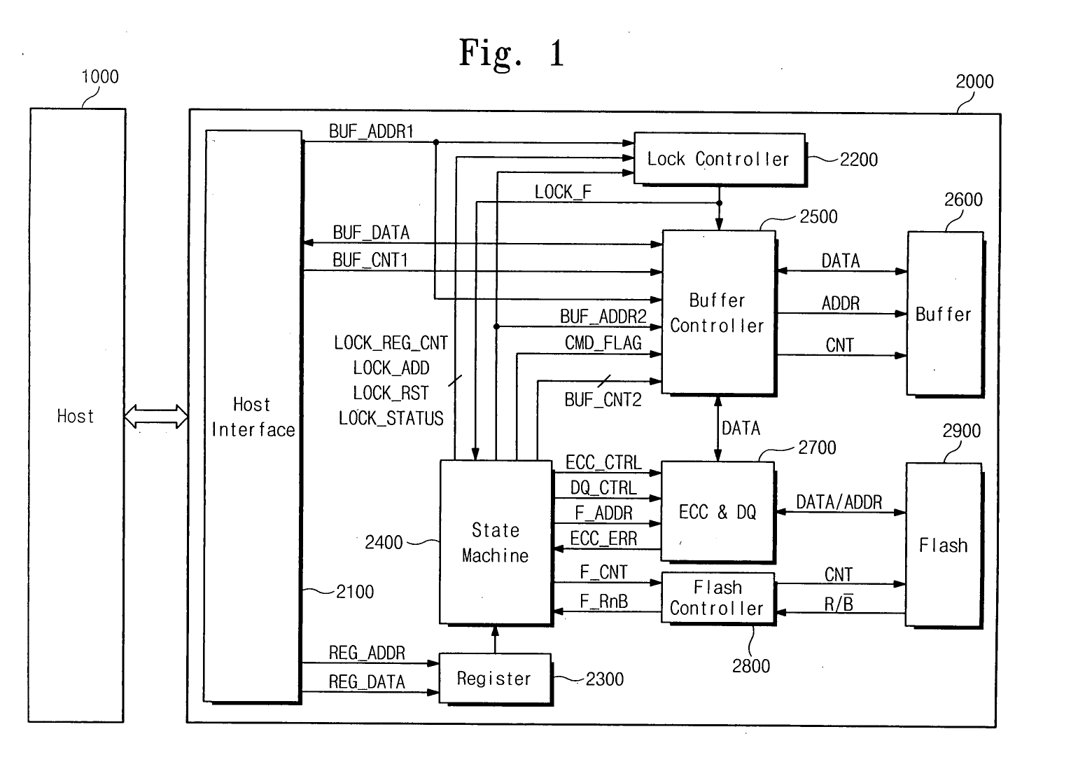

FIG. 1 is a block diagram illustrating an information processing system that includes a memory device according to certain embodiments of the present invention.

As shown in FIG. 1, the information processing system includes a memory device 2000 connected to a host 1000 through a bus. The memory device 2000 stores data or outputs stored data under the control of the host 1000. The memory device 2000 includes a host interface 2100 that acts as the interface with the host 1000. The host 30 interface 2100 may be embodied to operate in various interface modes such as, for example, a SRAM interface mode and/or a NOR flash memory interface mode.

The memory device 2000 also includes a buffer memory 2600 and a flash memory 2900. The host 1000 transfers data that will be stored to the memory device, and the memory device 2000 stores the transferred data temporarily in the buffer memory 2600. Next, the memory device 2000 reads the stored data in an internal operation from the buffer memory 2600 and stores the read data to the flash memory 2900. Similarly, to transfer data stored in the flash memory 2900 to the host, the data is read in the flash memory 2900, and the read data is temporarily stored in the buffer memory 2600. Then, the memory device 2000 reads the data stored in the buffer memory 2600 internally and transfers the read data to the host 1000.

In certain embodiments of the present invention, the buffer memory 2600 may be embodied using a SRAM. It will be understood, however, that the buffer memory 2600 can be embodied employing other types or configurations of random access memory. The host interface mode may be selected based on, for example, an interface mode associated with the device used to implement the buffer memory 2600.

To store important information such as, for example, the boot code, the buffer memory 2600 may be partially or wholly appointed. By “partially or wholly appointed” it is meant that a portion or all of the buffer memory 2600 is designated as a locked region that is write-protected so that information stored therein may not be overwritten. Important information that is available to the host 1000 may be stored in the buffer memory 2600. Important information such as, for example, the boot code, may be stored in a specific region of the flash memory 2900. During power-up, the boot code may be transferred from the flash memory 2900 to the buffer memory 2600, and other important information may be transferred by the host 1000 to the memory device 2000. If such information is stored in the buffer memory 2600, it is possible that an unintentional or erroneous operation that results from a bias, mistake or other condition may change the stored information. The memory device according to certain embodiments of the present invention can reduce or minimize the possibility of such changes to information that is stored in the portion of the buffer memory that is appointed by the host 1000, as will be described more fully herein.

As is also shown in FIG. 1, the memory device 2000 further includes a lock controller 2200 (a write protection controller), a register 2300, a state machine 2400, a buffer controller 2500, an error correction and data input/output block 2700 (denoted “ECC & DQ” in FIG. 1) and a flash controller 2800.

The lock controller 2200 decides whether or not an address BUF_ADDR1 that is transferred from the host 1000 through the host interface 2100 appoints a locked region (a write-protected region) of the buffer memory 2600. The lock controller 2200 activates a lockable flag signal LOCK_F according to the result of this decision. For example, if the address BUF_ADDR1 transferred from the host 1000 appoints the locked region of the buffer memory 2600, the lock controller 2200 activates the lockable flag signal LOCK_F by, for example, setting it to a high level. If instead the address BUF_ADDR1 transferred from the host 1000 does not appoint the locked region of the buffer memory 2600, the lock controller 2200 inactivates the lockable flag signal LOCK_F by, for example, setting it to a low level. Similarly, if an address BUF_ADDR2 transferred from the state machine 2400 appoints the locked region of the buffer memory 2600, the lock controller 2200 activates the lockable flag signal LOCK_F, whereas if it does not appoint the locked region of the buffer memory 2600, the lock controller 2200 inactivates the lockable flag signal LOCK_F.

The register 2300 in FIG. 1 may be used to store address and command information that is transferred from the host 1000 through the host interface 2100. For example, register data REG_DATA may be stored in the register 2300 that corresponds to a register address REG_ADDR. The register data REG₁₃ DATA may include, for example, a buffer memory address, a flash memory address, a read/write command, a lock address, a lock command, etc. This information may be stored in a region appointed by the register address REG_ADDR.

The state machine 2400 may operate by referring to values that are stored in the register 2300. For example, when a lock command and a lock address are loaded into the register 2300, the state machine 2400 may generate a control signal LOCK_REG_CNT that operates to store the lock address LOCK_ADD and lock state information LOCK_STATUS in the lock controller 2200. The state machine 2400 may also generate an initial signal LOCK_RST that initializes an address and/or a lock state information, which are stored in the lock controller 2200. When the lock flag signal LOCK_F from the lock controller 2200 is activated, the state machine 2400 may operate, for example, to prevent a read operation of the flash memory 2900 from being performed. The state machine 2400 may also control the buffer controller, the error correction and data input/output block 2700 and the flash controller 2800 according to one or more commands stored, for example, in the register 2300. Such control operations are more fully descried hereinafter.

As is also shown in FIG. 1, the buffer controller 2500 is controlled by the lockable flag signal LOCK_F and the state machine 2400. The buffer controller 2500 controls data read and write operations of the buffer memory 2600. The flash controller 2800 is likewise controlled by the state machine 2400, and controls data read and write operations of the flash memory 2900. The error correction and data input/output block 2700 may act to correct data errors that occur in transfers between the buffer controller 2500 and the flash memory 2900 under the control of the state machine 2400. The error correction and data input/output block 2700 also controls the transfer of data and address information to the flash memory 2900 according to determined timing.

In the embodiment of the present invention depicted in FIG. 1, the elements 2100-2900 of the memory device 2000 may be on a single chip (i.e., each element is formed on a common substrate such that the memory device 2000 is a single chip device). However, it will be evident to those skilled in the art that the memory device 2000 can be also be formed using more than one chip.

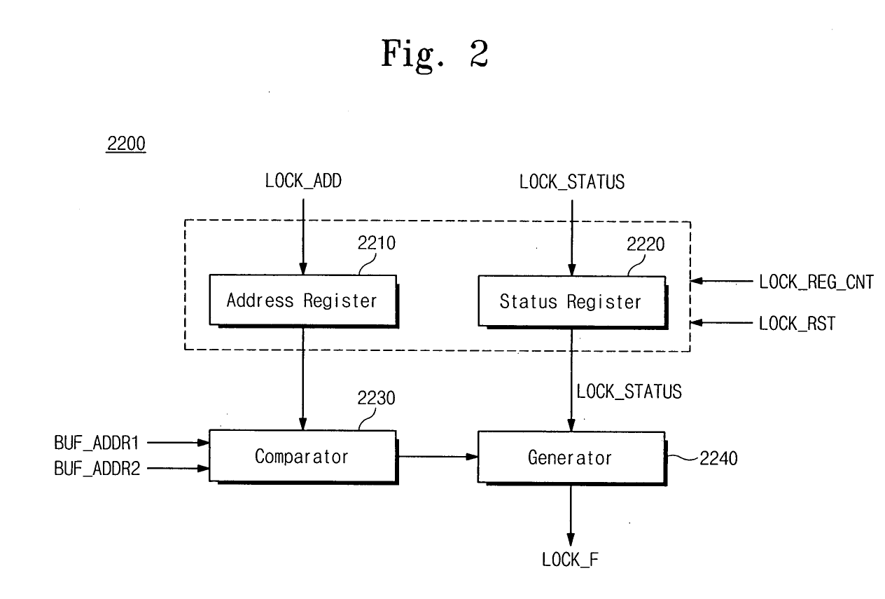

FIG. 2 is a block diagram illustrating certain embodiments of the lock controller 2200 of FIG. 1. As shown in FIG. 2, the lock controller 2200 may include an address register 2210, a state register 2220, a comparator 2230 and a lock flag generator 2240.

As shown in FIG. 2, the address register 2210 stores an address LOCK_ADD of the buffer memory 2600, which may be appointed to a locked region in response to a command from the state machine 2400. By way of example, in the embodiment depicted in FIG. 2, the address register 2210 stores the address LOCK_ADD in response to the control signal LOCK_REG_CNT. As is also shown in FIG. 2, in response to the control signal LOCK_REG_CNT from the state machine 2400, the state register 2220 stores the lock state information LOCK_STATUS, which indicates whether the buffer memory is partially or wholly appointed to the locked region. The address register 2210 and the state register 2220 may be initialized by the initial signal LOCK_RST from the state machine 2400. The state machine 2400 may generate a hardware-reset and a software-reset. The state machine 2400 may generate the initial signal LOCK_RST so that it is activated during power-up.

The comparator 2230 decides whether an input address BUF_ADDR1 from the host interface 2100 or an input address BUF_ADDR2 from the state machine 2400 is identical to an address stored in the address register 2210. The lock flag generator 2240 generates the lock flag signal LOCK_F in response to the lock state signal LOCK_STATUS from the state register 2220 and an output signal of the comparator 2230. For example, if the lock state signal LOCK_STATUS indicates that the buffer memory 2600 is partially or wholly appointed to the locked region, they lock flag signal LOCK_F becomes activated/inactivated according to the output signal of the comparator 2230. If, instead, the lock state signal LOCK_STATUS indicates that the buffer memory 2600 is not partially or wholly appointed to the locked region, the lock flag signal LOCK_F becomes inactivated irrespective of the output of the comparator 2230.

Operation of the information processing system according to certain embodiments of the present invention will now be more fully described with reference to FIGS. 1 and 2.

Operations may begin with the buffer memory 2600 being partially or wholly appointed to the locked region. For purposes of this example, it is assumed that the buffer memory 2600 is partially appointed to the locked region. This appointment may be accomplished as follows. The host 1000 transfers the register address REG_ADDR and the register data REG_DATA to the memory device 2000 via the host interface 2100. The host interface 2100 transfers the register address REG_ADDR and the register data REG_DATA to the register 2300. The register data REG_DATA may include the lock address and the lock command. The state machine 2400 generates the control signal LOCK_REG_CNT, the lock address LOCK_ADD and the lock state information LOCK_STATUS based on the information stored in the register 2300. The address register 2210 and the state register 2220 latch the lock address LOCK_ADD and the lock state information LOCK_STATUS, respectively, in response to the control signal LOCK_REG_CNT. The control signal LOCK_REG_CNT may, for example, comprise a pulse clock signal.

Important information or a boot code, which are controlled by the host 1000, may be stored in the locked region. The operation that stores the important information in the locked region is performed before the locked region is set up. Then, it is impossible for any information to be stored in the locked region of the buffer memory before the address and status registers 2210 and 2220 of the lock controller 2200 are initialized.

We will next describe exemplary operations that may be used to lock the buffer memory. In particular, an exemplary lock operation of the buffer memory during a data transmission process from the host to the flash memory will first be described, and then an exemplary lock operation of the buffer memory during a data transmission process from the flash memory to the host will be described.

The host 1000 transfers the address BUF_ADDR1, the data BUF_DATA and the control signal BUF_CNT1 to the memory device 2000. The data BUF_DATA is stored in the flash memory 2900, and the address BUF_ADDR1 is an address of the buffer memory 2600. Next, the host 1000 transfers an address of the flash memory 2900, an address of the buffer memory 2600 and read/write commands to the memory device 2000. The host interface 2100 of the memory device 2000 transfers the address of the flash memory 2900, the address of the buffer memory 2600 and the read/write commands to the register 2300. The operation that stores the data in the register 2300 may be performed before the operation that transmits the address BUF_ADDR1, the data BUF_DATA and control signals BUF_CNT1.

The comparator 2230 of the lock controller 2200 compares the input address BUF_ADDR1 with the lock address stored in the address register 2210. If the output of the comparator 2230 indicates that the input address BUF_ADDR1 is identical to the lock address stored in the address register 2210, the lock flag generator 2240 activates the lock flag signal LOCK_F in response to the output signal LOCK_STATUS of the state register 2220. When the lock flag signal LOCK_F becomes activated, the buffer controller 2500 controls the data BUF_DATA that is transferred through the host interface 2100 such that it is not stored in the buffer memory 2600. This can be accomplished, for example, by inactivating the control signals necessary to perform a data write operation.

When the LOCK_F signal is activated such that data cannot be stored in the buffer memory 2600, data that is already stored in the buffer memory is read under the control of the state machine 2400, and the read data is stored in the flash memory 2900. This operation acts to provide a back-up of the data that is stored in the locked region of the buffer memory 2600. This storage of information from the buffer memory 2600 in the flash memory 2900 may be accomplished as follows.

After the data read operation of the buffer memory 2600 is cut off, the state machine 2400 controls the buffer controller 2500, the ECC & DQ blocks 2700 and the flash controller 2800 so that data stored in the buffer memory 2600 is read depending on values stored in the register 2300 and that the read data is stored in the flash memory 2900. For instance, the state machine 2400 outputs a command flag signal CMD_FLAG for specifying a read operation, a control signal BUF_CNT2 and an address BUF_ADDR2. The comparator 2230 of the lock controller 2200 compares the input address BUF_ADDR2 with the lock address stored in the address register 2210. If the input address BUF_ADDR2 is not identical to the lock address stored in the address register 2210, the lock flag signal LOCK_F is set (or remains) in an inactivated state.

When the command flag signal CMD_FLAG specifies a read operation and the lock flag signal LOCK_F is in an inactivate state or when the command flag signal CMD_FLAG specifies a read operation and the lock flag signal LOCK_F is in an inactive state, the buffer controller 2500 controls the buffer memory so that data is read out from a region of the buffer memory 2600 corresponding to the address BUF_ADDR2. The read data is transferred to the ECC & DQ block 2700. Next, the state machine 2400 outputs the flash address F_ADDR to the ECC & DQ block 2700, where the flash address is obtained from the register 2300. The ECC & DQ block 2700 performs a function as an error correction under the control of the state machine 2400 and outputs a write command, an address and data to the flash memory 2900 according to determined timing. At the same time, the flash controller 2800 converts control signal F_CNT from the state machine 2400 into a control signal CNT suitable to the flash memory 2900 and then outputs the control signal CNT. Then, a data write operation to the flash memory may be performed in a known manner.

If the address BUF_ADDR1 transferred form the host 1000 is not identical to the lock address stored in the address register 2210, the lock flag generator 2240 inactivates the lock flag signal LOCK_F. If the lock flag signal LOCK_F is inactivated, the buffer controller 2500 controls the input data BUF_DATA so that it is stored in a region of the buffer memory 2600 that corresponds to the address BUF_ADDR1. After the data write operation to the buffer memory 2600 is performed, the state machine 2400 controls the buffer controller 2500, the ECC & DQ block 2700 and the flash controller 2800 in order that the data stored in the buffer memory 2600 is read according to values stored in the register 2300, and the read data is stored in the flash memory 2900. This operation will be performed in the same manner as described above, and description thereof is thus omitted.

As previously mentioned, when data is stored in the locked region of the buffer memory 2600, a data write operation of the locked region is cut off depending on a control of the lock controller 2200.

A lock operation of the buffer memory in a data transmission process from the flash memory to the host will now be described. To transfer data from the flash memory to the host, the data is read from the flash memory 2900, and the read data is stored in the buffer memory 2600. Before reading data from the flash memory 2900, it is determined through the lock controller 2200 whether the region where the data from the flash memory is written in the buffer memory 2600 is a locked region of the buffer memory 2600.

Specifically, the host 1000 transfers an address of the flash memory 2900, an address of the buffer memory 2600 and read/write commands to the host interface 2100. The host interface 2100 transfers this information to the register 2300. Next, the comparator 2230 of the lock controller 2200 compares the input address BUF_ADDR2 from the state machine 2400 with the lock address stored in the address register 2210. If the input address BUF_ADDR2 is identical to the lock address stored in the address register 2210, the lock flag generator 2240 activates the lock flag signal LOCK_F in response to the output LOCK_STATUS of the state register 2220 and the output of the comparator 2230. When the lock flag signal LOCK_F is activated, the state machine 2400 controls the data read operation of the flash memory 2900 so that it is not performed. This can be accomplished by, for example, by inactivating any or all of control signals needed to perform a data read operation of the flash memory 2900.

If the input address BUF_ADDR2 is not identical to the lock address stored in the address register 2210, the state machine 2400 controls the ECC & DQ block 2700 so that an address and a command are transferred to the flash memory 2900 according to determined timing. At the same time, the state machine 2400 controls the flash controller 2800 in order that the control signals necessary to perform a data read operation are transferred to the flash memory 2900. The read data is transferred in a known manner from the flash memory 2900, through the ECC & DQ block 2700, to the buffer controller 2500. Next, the state machine 2400 outputs the address BUF_ADDR2, the command flag signal CMD_FLAG and control signals BUF_CNT2 to the buffer controller 2500. The buffer controller 2500 controls the buffer memory 2600 so that the read data from the flash memory 2900 is stored in the region of the buffer memory 2600 corresponding to the address BUF_ADDR2. The data is then read from the buffer memory 2600 and transferred through the buffer controller 2500 and the host interface 2100 to the host 1000.

In an operation between the flash memory 2900 and the buffer memory 2600, if the host 1000 transfers data of the flash memory 2900 to the locked region of the buffer memory 2600, as previously mentioned, the memory device 2000 is not operated any more and then may transfer error information to the host 1000. A lock state information stored in the state register 2220 of the lock controller may disappear when power is turned on or off.

As previously mentioned, the buffer memory region for storing important information may be set up as a locked region, and read operations of the locked region may be prevented. As a result, the device can prevent important information stored in the locked region from being changed by, for example, a mistake or bias.

While this invention has been particularly shown and described with reference to exemplary embodiments thereof, it will be understood by those skilled in the art that various changes in form and details may be made therein without departing from the spirit and scope of the invention as defined by the appended claims and equivalents.

1. A memory device comprising:
a non-volatile memory;
a volatile memory that is configured to store data that is to be stored in the non-volatile memory and data read from the non-volatile memory; and
at least one control circuit that receives an address designating at least one address of the volatile memory as a locked region.

2. The memory device of claim 1, wherein the at least one control circuit is configured to:
generate a flag signal that indicates whether an input address corresponds to the locked region; and
control read and write operations of the non-volatile and volatile memories in response to the flag signal such that write operations are not performed to the volatile memory when the flag signal is activated.

3. The memory device of claim 1, wherein the at least one control circuit further controls the volatile and non-volatile memories in response to the flag signal such that data stored in the volatile memory is read and stored in the non-volatile memory when the flag signal is activated.

4. The memory device of claim 1, wherein when the flag signal is activated, the at least one control circuit controls the non-volatile memory such that no read operation of the non-volatile memory is performed.

5. The memory device of claim 1, wherein when the flag signal is inactivated, the at least one control circuit controls the volatile and non-volatile memories so as to allow write operations to the volatile memory and to allow read operations of the non-volatile memory device.

6. The memory device of claim 1, wherein the at least one control circuit comprises:
an address register for storing an address to appoint the locked region of the volatile memory;
a status register for storing information indicating whether the volatile memory is partially or wholly appointed to the locked region;
a comparator for deciding whether the input address is identical to the address stored in the address register; and
a signal generator for generating the flag signal in response to outputs of the status register and the comparator.

7. The memory device of claim 6, wherein when the information stored in the status register indicates that the volatile memory is partially or wholly appointed to the locked region, the signal generator activates or inactivates the flag signal based on the output of the comparator.

8. The memory device of claim 6, wherein when the information stored in the status register indicates that the volatile memory is not partially or wholly appointed to the locked region, the signal generator inactivates the flag signal irrespective of the output of the comparator.

9. The memory device of claim 6, wherein the at least one control circuit initializes the address register and the status register in response to a hardware-reset, a software-reset, and/or a turning on of the power to the memory device.

10. The memory device of claim 6, wherein the at least one control circuit further comprises a register for storing an address of the locked region and a lock command.

11. The memory device of claim 1, wherein the volatile memory, the non-volatile memory and the at least one control circuit are formed on a single chip.

12. A memory device comprising:
a volatile memory;
a register that is configured to store an address appointing a locked region of the volatile memory and a lock command;
a state machine that is configured to output the address appointing the locked region, the lock command and a control signal when the lock command is input to the register;
a control circuit that is configured to store the address appointing the locked region and the lock command in response to the control signal, and to generate a flag signal indicating whether an address for appointing a predetermined region of the volatile memory is an address for appointing the locked region; and
a first memory controller that is configured to prevent write operations to the volatile memory when the flag signal is activated.

13. The memory device of claim 12, wherein when the flag signal is activated, the first memory controller makes the volatile memory perform an operation corresponding to an input command.

14. The memory device of claim 12, further comprising:
a non-volatile memory;
an error correction and data input/output circuit, which is controlled by the state machine and corrects an error of data transmitted between the first memory controller and the non-volatile memory; and
a second memory controller which is controlled by the state machine and controls read and write operations of the non-volatile memory.

15. The memory device of claim 14, wherein when the flag signal is activated, the state machine controls the first and second memory controllers so that data is read from the volatile memory and stored in the non-volatile memory.

16. The memory device of claim 14, wherein when the flag signal is activated, the state machine controls the second memory controller so that read operations of the non-volatile memory are not performed.

17. The memory device of claim 14, wherein the control circuit comprises:
an address register that is configured to store the address appointing the locked region in response to the control signal;
a status register that is configured to store the lock command in response to the control signal;
a comparator that compares the address in the address register to the address appointing a predetermined region of the volatile memory; and
a signal generator for generating the flag signal in response to outputs of the status register and the comparator.

18. The memory device of claim 17, wherein when the information stored in the status register indicates that the volatile memory is partially or wholly appointed to the locked region, the signal generator activates or inactivates the flag signal based on the output of the comparator.

19. The memory device of claim 17, wherein when the information stored in the status register indicates that the volatile memory is not partially or wholly appointed to the locked region, the signal generator inactivates the flag signal irrespective of the output of the comparator.

20. The memory device of claim 17, wherein the control circuit controls the initializes the address register and the status register in response to a hardware-reset, a software-reset, and/or a turning on of the power to the memory device.

21. A method of controlling a memory system having a non-volatile memory and a volatile memory, the method comprising:
receiving data that is to be stored in the non-volatile memory;
temporarily storing the received data in the volatile memory;
storing the temporarily stored data in the non-volatile memory;
receiving an address designating a region of the volatile memory as a locked region;
receiving an input address; and
determining whether the input address corresponds to the locked region.

22. The method of claim 21, further comprising controlling operations of the non-volatile and volatile memories such that write operations are not performed to the volatile memory if it is determined that the input address corresponds to the locked region.

23. The method of claim 22, further comprising controlling the volatile and non-volatile memories such that data read from the volatile memory is stored in the non-volatile memory if it is determined that the input address corresponds to the locked region.

24. The method of claim 22, further comprising controlling operations of the non-volatile and volatile memories such that write operations of the volatile memory are not performed if it is determined that the input address corresponds to the locked region.

25. The method of claim 21, wherein determining whether the input address corresponds to the locked region comprises:
storing the received address designating a region of the volatile memory as a locked region;
storing information indicating whether the volatile memory is partially or wholly appointed to the locked region;
activating a flag signal if the input address is identical to the address designating a region of the volatile memory as a locked region and the stored information indicates that the volatile memory is partially or wholly appointed to the locked region.

26. A method of controlling a memory system having a volatile memory, the method comprising:
storing an address appointing a locked region of the volatile memory;
storing a lock command;
generating a flag signal indicating whether an address for appointing a predetermined region of the volatile memory is an address for appointing the locked region; and
preventing write operations to the volatile memory when the flag signal is activated.

27. The method of claim 26, wherein the memory system further comprises a non-volatile memory, and wherein the method further comprises reading data from the volatile memory and storing the read data in the non-volatile memory when the flag signal is activated.

28. The method of claim 26, further comprising preventing read operations of the non-volatile memory when the flag signal is activated.

29. A system comprising:
a host; and
a memory device for storing data according to a request of the host and outputting the stored data, wherein the memory device comprises:
a non-volatile memory;
a volatile memory for storing data to be stored in the non-volatile memory and data read from the non-volatile memory;
a lockable control circuit for receiving an address appointing a predetermined region of the volatile memory and generating a lockable flag signal, wherein the lockable flag signal notifies whether the input address corresponds to a locked region of the volatile memory; and
a control circuit for controlling read and write operations of the non-volatile and volatile operations in response to the lockable flag signal, wherein when the lockable flag signal becomes activated, the control circuit controls the volatile memory such that no write operation of the volatile memory is performed.

30. The system of claim 29, wherein the volatile memory, the non-volatile memory, the lock controller and the control circuit are formed of a single chip.

31. The system of claim 29, wherein when the lockable flag signal becomes activated, the control circuit controls the volatile and non-volatile memories in order that data read from the volatile memory is stored in the non-volatile memory.

32. The system of claim 29, wherein when the lockable flag signal becomes activated, the control circuit controls the non-volatile memory such that no read operation of the volatile memory is performed.

33. A system comprising:
a host; and
a memory device for storing data according to a request of the host and
outputting the stored data, wherein the memory device comprises:
a volatile memory;
a register receiving a lockable command and a lockable address for appointing a locked region of the volatile memory from the host;
a state machine for generating the lockable address, the lockable command and a control signal when the lockable command is input to the register;
a lockable control circuit for storing the lockable address and the lockable command in response to the control signal, and generating a lockable flag signal for notifying whether an address for appointing a predetermined region of the volatile memory is an address for appointing the locked region or not; and
a first memory controller for controlling a write operation of the volatile memory
according to whether the lockable flag signal is activated when a write command is input from the host or the state machine, wherein the memory controller cuts the write operation of the volatile memory when the lockable flag signal is activated.

34. The system of claim 33, wherein when the lockable flag signal is activated, the first memory controller makes the volatile memory perform an operation corresponding to an input command.

35. The system of claim 33, wherein the memory device further comprises:
a non-volatile memory;
an error correction and data input/output circuit, which is controlled by the state machine and corrects an error of data transmitted between the first memory controller and the non-volatile memory; and
a second memory controller which is controlled by the state machine and controls read and write operations of the non-volatile memory.

36. The system of claim 35, wherein when the lockable flag signal becomes activated, the state machine controls the first and second memory controllers in order that data read from the volatile memory is stored in the non-volatile memory.

37. The system of claim 35, wherein when the lockable flag signal becomes activated, the state machine controls the second memory controller in order that the read operation of the non-volatile memory is not performed.

38. The system of claim 35, wherein when the lockable flag signal becomes activated, the state machine controls the first and second memory controllers in order that the write operation of the volatile memory and the read operation of the non-volatile memory are performed.

39. The system of claim 35, wherein when the lockable control circuit comprises:
an address register for storing the lockable address in response to the control signal;
a status register for storing the lockable command in response to the control signal;
a comparator for deciding whether a transmitted address from the outside is identical to an address stored in the address register; and
a signal generator for generating the lockable flag signal in response to outputs of the status register and the comparator.

40. The system of claim 39, wherein when information stored in the status register notifies that the volatile memory is not partially or wholly appointed to the locked region, the signal generator inactivates the lockable flag signal irrespective of the output of the comparator.

41. The system of claim 39, wherein the state machine controls the lockable control circuit for a initial signal so as to initialize at hardware-reset, a software-reset, or power-on.
